(19) United States
(12) Patent Application Publication
(10) Pub. No.: US 2022/0330677 A1
(43) Pub. Date: Oct. 20, 2022

(54) SHAVING RAZOR KIT

(71) Applicant: The Gillette Company LLC, Boston, MA (US)

(72) Inventors: Mark Peterson, Reading (GB); Daniel Edward Dunham, Reading (GB); Nicola Louise Caton, Reading (GB)

(21) Appl. No.: 17/723,004

(22) Filed: Apr. 18, 2022

Related U.S. Application Data
(60) Provisional application No. 63/175,948, filed on Apr. 16, 2021.

(51) Int. Cl. A45D 27/29

(52) U.S. Cl. CPC A45D 27/29; B26B 21/06

(57) ABSTRACT

A shaving razor kit with a plurality of shaving razors each having a handle with a proximal end and a distal end. A plurality of shaving razor cartridges are each mounted to the corresponding proximal end of the handle. A shaving razor container has a top surface defining and upper opening and a bottom surface that defines a lower opening in communication with the upper opening. The shaving razors have a first position with the shaving razor cartridges positioned within the shaving razor container toward the bottom surface. The shaving razors have a second position with the shaving razor cartridges are positioned externally of the shaving razor container.

### FIELD OF THE INVENTION

The present invention relates to recyclable consumer goods and more particularly, to shaving razors and containers that facilitate the storage and the recycling process for consumer and/or recyclers.

### BACKGROUND OF THE INVENTION

More consumers are starting to demand the products they purchase are more environmentally sustainable. Consumers want to be able to easily recycle their products after they are finished using them. If a product is not easy to recycle, then consumers will throw the products in with the general waste (e.g., trash) and they will eventually end up in a land fill or incinerated. Material recovery facilities and recyclers have very stringent requirements to enable material recovery, which makes personal care products, such as shaving razors, difficult or impossible to recycle. Before materials for consumer goods can be recycled, recovered and reprocessed they must go through a sorting process and/or size screening process. Small products, roughly two inches or smaller have a high risk of failure at this stage. Razor handles and cartridges can get caught or fall between the belts and gears of the machinery. Accordingly, these smaller items are then potentially lost from the material recovery stream and will be directed to landfill or incineration. Shaving razors and handles are also problematic for recyclers because they are composed of numerous types of materials, which are difficult to separate for recovery and reprocessing. Shaving razors and cartridges may be composed of steel, aluminum, and different types of plastics that all must be separated into different recycling streams. Consumers may become injured trying to disassemble shaving razors. Recyclers do not have the capabilities to disassemble these types of products and it is not financially viable for them to invest in doing so.

Accordingly, there is a need to develop processes, containers and products that facilitate the recycling of personal care products, such as shaving razors. Despite current products, processes and equipment, there remains a need to develop shaving razors and containers that meet the current requirements of recyclers.

### SUMMARY OF THE INVENTION

In one aspect, the invention features, in general, a shaving razor container with a top surface defining an upper opening. The top surface has a first pair of inner side walls defining a slot. A bottom surface of the shaving razor container defines a lower opening in communication with the upper opening. A side surface of the shaving razor container extends between the top surface and the bottom surface. A first projection extends from the bottom surface toward the top surface. The slot and the projection are configured to engage a shaving razor handle.

In another aspect, the invention features, in general, a shaving razor kit with a plurality of shaving razors each having a handle with a proximal end and a distal end. A plurality of shaving razor cartridges are each mounted to the corresponding proximal end of the handle. A shaving razor container has a top surface defining and upper opening and a bottom surface that defines a lower opening in communication with the upper opening. The shaving razors have a first position with the shaving razor cartridges positioned within the shaving razor container toward the bottom surface. The shaving razors have a second position with the shaving razor cartridges are positioned externally of the shaving razor container.

In another aspect, the invention features, in general, a method of recycling by providing a plurality of shaving razors comprising at least 80% of a first metal by weight. A shaving razor container is provided made of at least 80% of the first metal by weight. The plurality of shaving razors are positioned within the shaving razor container. The plurality of shaving razors are at least partially secured within the shaving razor container.

In another aspect, the invention features, in general, a method of assembling a shaving razor by providing a handle having a proximal end with a platform, a distal end and a gripping portion between the proximal end and the distal end. A frame is provided having a top guard surface, a top cap surface and a pair of top side surfaces defining an opening. At least one blade member having a pair of lateral ends is mounted within a slot and on a pair of blade supports. The blade supports are secured to the platform. The frame is mounted over the pair of lateral ends of the at least one blade member and the pair of blade supports. The frame is secured to the platform.

In another aspect, the invention features, in general, a shaving razor with a handle having a proximal end with a platform, a distal end and a gripping portion between the proximal end and the distal end. A frame is mounted to the platform. The frame has a top guard surface, a top cap surface and a pair of top side surfaces defining an opening. A pair of spaced apart blade supports each define at least one blade slot. A blade is mounted within the slot of each of the blade supports. The frame is mounted over the blade supports.

### BRIEF DESCRIPTION OF THE DRAWINGS

FIG. 1A is a top perspective view of one possible embodiment of shaving razor container.

FIG. 1B is a bottom perspective view of the shaving razor container if FIG. 1A.

FIG. 2A is a front perspective view of one possible embodiment of shaving razor.

FIG. 2B is a rear perspective view of the shaving razor of FIG. 2A.

FIG. 2C is a side view of the shaving razor of FIG. 2A.

FIG. 3A is a top perspective view of several of shaving razors of FIG. 2A secured within the consumer product container of FIG. 1A in a first position.

FIG. 3B is a top perspective view of several of shaving razors of FIG. 2A positioned within the consumer product container of FIG. 1A in a second position.

FIG. 4 is a cross sectional view taken generally along the line 4-4 of FIG. 3A.

FIG. 5 is an assembly view of the shaving razor of FIG. 2A.

FIG. 6 is a flowchart illustrating a method for recycling one or more shaving razors.

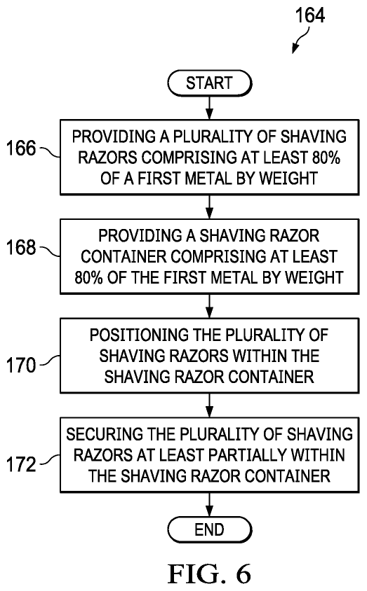

### DETAILED DESCRIPTION OF THE INVENTION

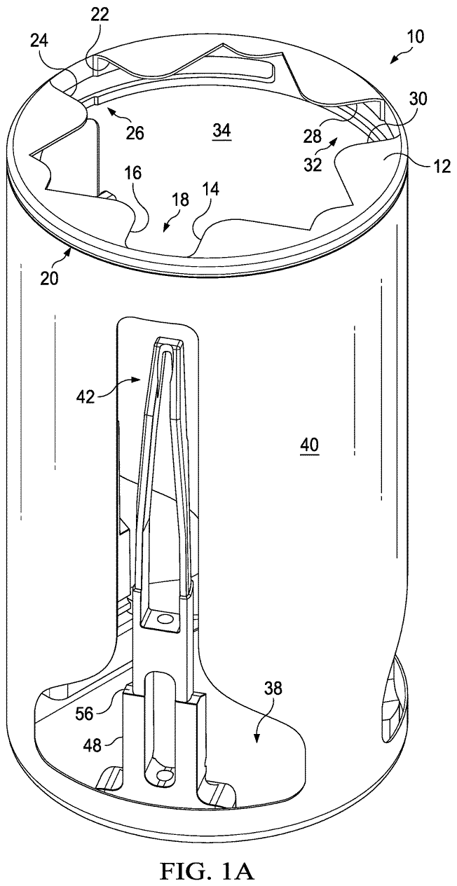

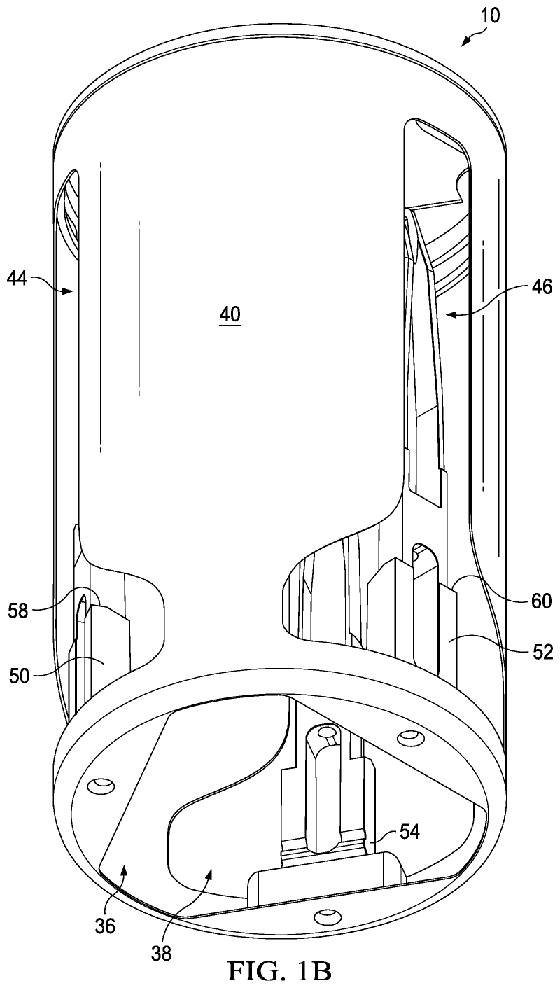

Referring to FIGS. 1A and 1B, one possible embodiment of the present invention is shown illustrating a first and second perspective views of a shaving razor container 10. In certain embodiments, the shaving razor container 10 may be manufactured from various grades of aluminum or steel. In certain embodiments, the shaving razor container 10 may comprise at least 80% of a ferrous or non-ferrous material. Examples may include aluminum or steel so it can be easily processed through standard recycling streams. Although the purpose of the shaving razor container 10 is for recycling shaving razors, it is understood that the shaving razor container 10 may be utilized for other consumer goods. The shaving razor container 10 may have a top surface 12 with a first pair of inner side walls 14 and 16 defining a slot 18 configured to receive a first shaving razor handle (not shown). The top surface 12 may have a circular rim 20. The shaving razor container 10 may be in the shape of a can (e.g., aluminum beverage cans), which is generally recognized globally as an easily recycled product. The top surface 12 may also have a second pair of inner side walls 22 and 24 defining a slot 26 configured to receive a second shaving razor handle (not shown). Although the shaving razor container 10 may hold one or two shaving razors (not shown), the circular shape of the shaving razor container 10 ideally holds three shaving razors because of the geometry of typical “T” shaped shaving razors. Accordingly, the top surface 12 may include a third pair of inner side walls 28 and 30 defining a slot 32 configured to receive a third shaving razor handle (not shown).

The top surface 12 of the shaving razor container 10 may define an upper opening 34 that extends through the shaving razor container 10 to a bottom surface 36 that defines a lower opening 38. The upper opening 34 may allow a shaving razor (not shown) to be inserted into the shaving razor container 10. The lower opening 38 may allow smaller objects to pass through the shaving razor container 10 so they are not inadvertently recycled along with the shaving razor container 10. A side surface 40 may extend between and connect the top surface 12 and the bottom surface 36 of the shaving razor container 10. In certain embodiments, the side surface 40 may be rounded (e.g., the shaving razor container 10 may be generally cylindrical). The side surface 40 may define one or more windows 42, 44 and 46. The windows 42, 44 and 46 may not only allow the removal of excess material from the shaving razor container 10, but may allow the consumer to see the inside of the shaving razor container 10 so they may properly insert a shaving razor (not shown). The shaving razor container 10 may have one or more projections 48, 50 and 52 extending from the bottom surface 36 toward the top surface 12 that is configured to engage a respective shaving razor handle (not shown). The projections 48, 50 and 52 may be positioned and/or viewable from within the respective windows 42, 44 and 46. In certain embodiments, the projection(s) 48, 50 and 52 may be spaced apart from the side surface 40. The projection(s) 48, 50 and 52 may be positioned within the respective apertures 42, 44 and 46. As will be explained in greater detail below, the projections 42, 44 and 46 may each have one or more first resting surfaces 54, such as a notch configured to engage a respective shaving razor cartridge (not shown). The projections 42, 44 and 46 may also have one or more second resting surfaces 56, 58 and 60 (e.g., a shoulder) configured to support a shaving razor handle (not shown). The second resting surfaces 56, 58 and 60 may be positioned above the first resting surface(s) 54 (i.e., closer to the top surface 12). Accordingly, the projections 42, 44 and 46 may facilitate holding a shaving razor (not shown) with the shaving razor cartridge (not shown) facing the bottom surface 36 or the top surface 12. The various portions (e.g., the top surface 12, the bottom surface 36, the side surface 40 and the projections 48, 50 and 52) that make up the shaving razor container 10 may be at least 80% aluminum or steel to facilitate recycling and more preferably greater than 90% aluminum or steel. In certain embodiments, the shaving razor container 10 may be about 95% to 100% aluminum or steel.

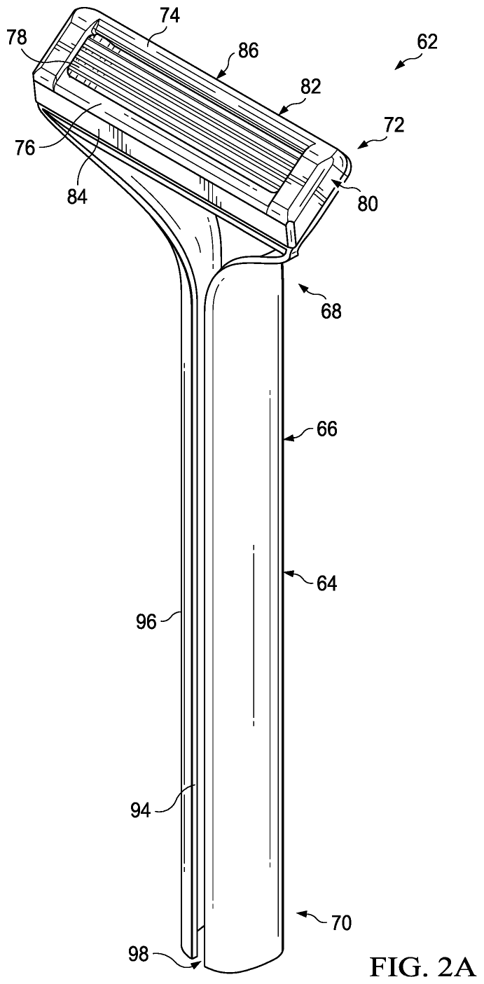

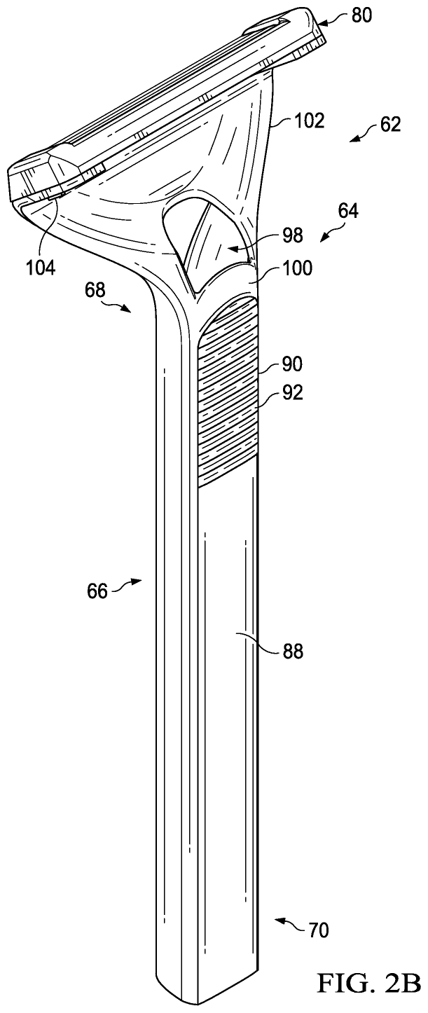

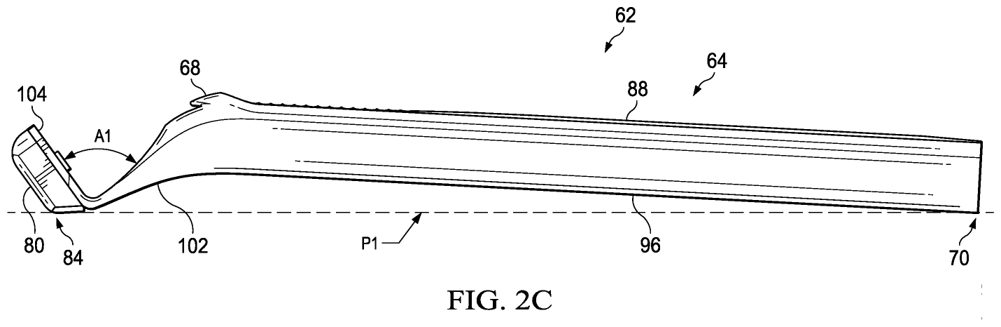

Referring to FIGS. 2A and 2B, one possible embodiment of the present invention is shown illustrating a first and second perspective views of a shaving razor 62. The shaving razor 62 may include a handle 64 having a gripping portion 66 with a proximal end 68 and a distal end 70. A shaving razor cartridge 72 may be mounted to the proximal end 68 of the gripping portion 66. The shaving razor cartridge 72 may have a top cap surface 74, a top guard surface 76 and at least one blade member 78 positioned between the top guard surface 76 and the top cap surface 74. In certain embodiments, the shaving razor cartridge 72 may be permanently fixed to the handle 64. For example, the one or more blade members 78 may be mounted within a frame 80 that is formed from a uniform piece of material as the handle 64 (e.g., aluminum). The top cap 74 surface and the top guard surface 76 may be part of a top surface 82 of the frame 80. The top guard surface 76 may be positioned toward a front 84 of the frame 80 and the top cap surface 74 may be positioned toward a rear 86 of the frame 80. In certain embodiments, the top cap surface 74 may be coated with lubricous material or treated to (e.g., silicone coating or anodized) to improve the glide of the shaving razor cartridge 72 during a shaving stroke. The top guard surface 76 may be heavily textured (e.g., knurling) and/or coated with a high friction coating to improve skin stretch during a shaving stroke.

The handle 64 may have a top surface 88 with a finger pad 90 positioned toward the proximal end 68 of the handle 64. The finger pad 90 may include a plurality of protrusions 92 (such as ridges or bumps) to provide improved tactile functionality for the user. The handle 64 may define a slot 94 extending from the proximal end 68 to the distal end 70. The slot 94 may be defined by a bottom surface 96 of the handle 64 (e.g., gripping portion) opposite the top surface 88. The positioning of the slot 94 on the bottom surface 96 opposite the finger pad 90 on the top surface 88 may provide a more comfortable grip for the user. For example, the skin of a user's finger may get caught in the slot 94. The slot 94 may have sharper edges, which do not provide a comfortable surface for the fingers of consumers that use typical shaving grips. The handle 64 may define an opening 98 that extends from the proximal end 68 to the distal end 70. The finger pad 90 may also provide a larger surface area than the bottom surface 96 having the slot 94, which also provides a more comfortable and secure grip of the shaving razor 62. The top surface 88 of the handle 64 may include a lip 100 positioned between the finger pad 90 and the opening 98 at the proximal end 68. The lip 100 may extend upward from the finger pad 90 to provide a stop surface for a consumer's finger. The slot 94 and the opening 98 extending completely through the handle 64 may help minimize material and decrease weight, both of which are important to provide a more sustainable handle 64 and shaving razor 62. The opening 98 may be dimensioned to receive at least a portion of the projection(s) 48, 50 and 52 of FIGS. 1A and 1B. A majority of the shaving razor 62 may comprise a single material (e.g., aluminum or steel) to facilitate recycling. For example, the blade member 78 may comprise steel. However, the amount of overall weight of the blade members 78 may be small enough compared to the remainder of the handle 64 and the frame 80 that comprise aluminum to allow for efficient recycling. In certain embodiments, the shaving razor 62 may be greater than 80% percent by weight of various grades of aluminum or steel. More preferably, the shaving razor 62 may be greater than 90% percent by weight of various grades of aluminum or steel.

Referring to FIG. 2C, a side view of the shaving razor 62 with the handle 64 in an at rest position on a generally horizontal surface or plane P1. The handle 64 may have a head 102 that extends between the frame 80 and the proximal end 68. The frame 80 may be mounted to a platform 104 that extends from the head 102. In certain embodiments, the platform 104 may extend at an angle A1 of about 80 degrees to about 100 degrees relative to the head 102. The frame 80 may be fixed relative to the handle 62 (e.g., the gripping portion 66). The handle 62 may be unitary, such that the platform 104, the head 102 and the gripping portion 66 comprise the same material (e.g., steel or aluminum) to facilitate recycling after the user has finished using the shaving razor 62. In the at rest position, the slot 94 of the handle 64 and the top surface 88 of the frame 80 may face the horizontal surface P1. In the at rest position on the generally horizontal surface P1, the areas of contact with the horizontal surface P1 may include the bottom surface 96 of the handle 64 at the distal end 70 and the front 84 of the housing 78. In certain embodiments, the platform 104 and/or the head 102 may contact the horizontal surface P1, which may facilitate preventing the top guard surface 76, the top cap surface 74 and the blade member 78 (i.e., shaving features) from contacting the generally horizontal surface P1. The generally horizontal surface P1 may represent a sink or countertop that a consumer may rest the shaving razor 62. The spacing of the top guard surface 76, the top cap surface 74 and the blade member 78 (i.e., shaving features) away from the generally horizontal surface P1 may be more desirable from a hygiene perspective by keeping the top guard surface 76, the top cap surface 74 and the blade member 78 clean from any dirt and debris on the sink or countertop.

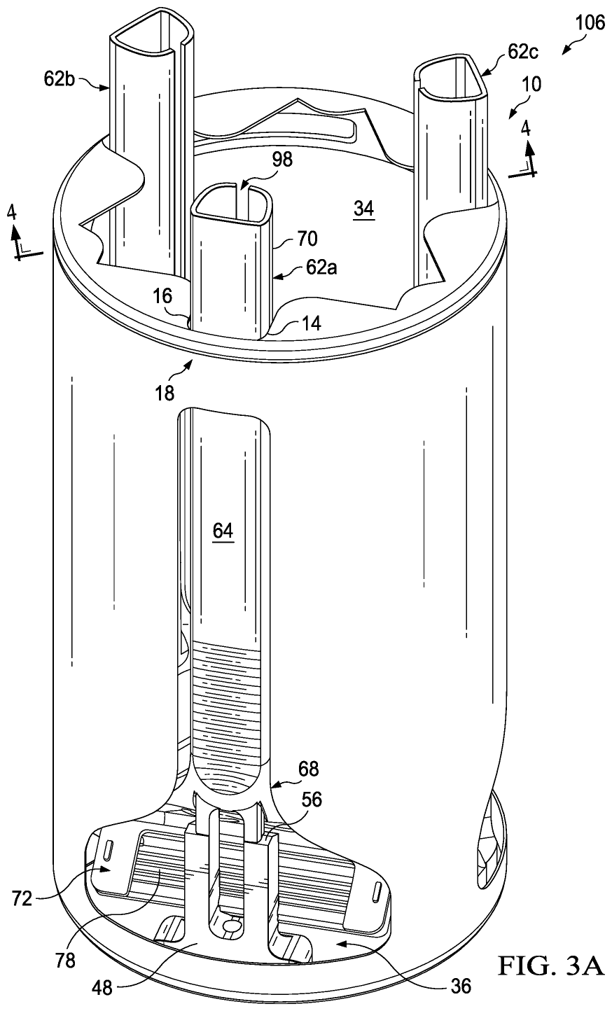

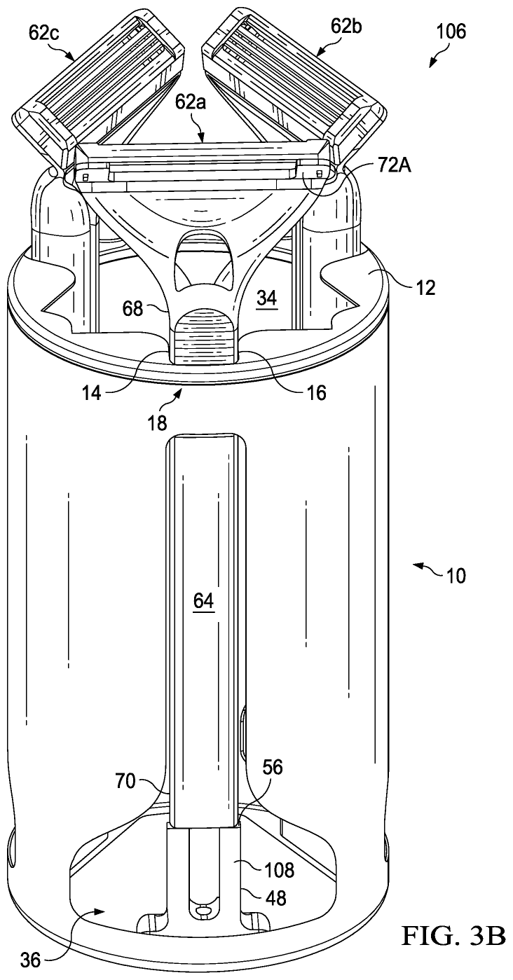

Referring to FIG. 3A, a perspective view is shown of a shaving razor kit 106 with a plurality of the shaving razors 62 positioned within the shaving razor container 10 (e.g., a first shaving razor 62a, a second shaving razor 62b and a third shaving razor 62c). FIG. 3A illustrates three of the shaving razors 62a, 62b and 62c in a first position within the shaving razor container 10. The first position may represent a recycled position of the shaving razors 62a, 62b and 62c (i.e., they are secured within the shaving razor container 10 and are ready to be sent to a recycling center). Accordingly, the shaving razors 62a, 62b and 62c do not become separated during shipping and handling during the transportation and recycling process. Although the shaving razor 62a is described, it is understood that the other shaving razors 62b and 62c may be inserted into the shaving razor container 10 in a similar fashion, as shown in FIG. 3A. Once a consumer has shaved a sufficient number of times such that the performance of the shaving razor 62a is no longer acceptable, the consumer may insert the shaving razor 62a into the opening 34 (the shaving cartridge 70 side first). The handle 64 may be positioned within the slot 18 of the container 10, such that the handle 64 engages the inner side walls 14 and 16 of the top surface 12. The opening 98 toward the proximal end 68 of the handle 64 may be inserted over the projection 48 (FIG. 1A) such that the shaving razor cartridge 72 is positioned toward the bottom surface 36. Accordingly, at least a portion of the projection 48 may be received within the opening 98 of the handle 64. The projection 48 may secure the handle 64 to the shaving razor container 10 so the shaving razor 62 and the container 10 do not become separated during the transportation process to a recycler. The securement of the handle 64 to the shaving razor container 10 may also make it more difficult for the consumer to remove the shaving razor 62. This may aid the consumer in determining which shaving razors 62 have been used and are ready to be recycled (i.e., the first position shown in FIG. 3A) from shaving razors 62 that are new or are at least sufficient for shaving.

In certain embodiments, the shaving razor cartridge 72 may be spaced apart from the bottom surface 36 in the first position to allow for water and/or shaving debris to drain off of the shaving razor cartridge 72. In the first position, the shaving razor cartridge 72 may be positioned within the shaving razor container 10 and the distal end 70 of the handle 64 may be positioned externally of the shaving razor container 10. The distal end 70 being positioned externally of the shaving razor container 10 may allow the consumer to safely remove the shaving razor 62a from the shaving razor container 10, if desired. In the first position, the blade member 78 of the shaving razor cartridge 72 may face inward. The position of the shaving razor 62a in the first position may prevent exposure of the blade member 78, thus minimizing the risk of inadvertently injuring anyone during the recycling shipping and handling process. The other shaving razors 62b and 62c, may be inserted into the shaving razor container 10 in a similar fashion. For example, when the consumer no longer intends on using them.

Referring to FIGS. 3B, a perspective view is shown of the shaving razor kit 106 with the shaving razors 62a, 62b and 62c engaged within the shaving razor container 10 in a second position. It is understood that the shaving razors 62a, 62b and 62c may be positioned within the shaving razor container 10 in any combination of the first position and/or second position. FIG. 3B illustrates all three of the shaving razors 62a, 62b and 62c in the second position within the shaving razor container 10. The second position may represent an in use position of the shaving razors 62a, 62b and 62c. For example, the second position may hold the shaving razors 62a, 62b and 62c in an upright position in-between shaves to facilitate keeping the shaving razors 62a, 62b and 62c dry and clean. Accordingly, in the second position, the shaving razors 62a, 62,b and 62c are releasably positioned within the shaving razor container 10.

Although the shaving razor 62a is described, it is understood that the other shaving razors 62b and 62c may be inserted into the shaving razor container 10 in a similar fashion, as shown in FIG. 3B. Once a consumer finishes shaving, the shaving razor 62a may be inserted into the opening 34 with the distal end 68 of the handle 64 first. The handle 64 may be positioned within the slot 18 such that the handle 64 engages the inner side walls 14 and 16 of the top surface 12. The opening 98 (FIG. 3A) toward the distal end 70 of the handle 64 may be inserted over the projection 48 (FIG. 1A) such that the distal end 70 of the handle 64 is positioned toward the bottom surface 36. Accordingly, at least a portion of the projection 48 may be received within the opening 98 (FIG. 3A) of the handle 64. The projection 48 may have a lower portion 108 to support the handle 64. For example, the distal end 70 of the handle 64 may contact the second resting surface 56 of the lower portion 108 of the projection 48. Accordingly, the distal end 70 of the handle 64 may be spaced apart from the bottom surface 36 of the shaving razor container 10, which may facilitate drying of the shaving razor 62a. The proximal end 68 of the handle 64 and the shaving razor cartridge 72 may be positioned externally of the shaving razor container 10, while the distal end 70 of the handle 64 is positioned within the shaving razor container 10 (in the second position). The proximal end 68 of the handle 64 being positioned outside of the shaving razor container 10 may allow the consumer to easily grab and remove the shaving razor 62a from the shaving razor container 10 without contacting the shaving razor cartridge 72a, which may result in getting cut.

The projection 48 may hold the handle 64 within the shaving razor container 10 so it can be easily removed when the consumer is ready to shave again. In certain embodiments, the force needed to remove the shaving razors 62a, 62b and 62c in the second position (FIG. 3B) from the shaving razor container 10 may be less than the force needed to remove the shaving razors 62, 62b and 62c in the first position (FIG. 3A) from the shaving razor container 10. Consumers want to be able to remove the shaving razors 62a, 62b and 62c easily when they want to shave, but want the shaving razors 62a, 62b and 62c to lock within the shaving razor container 10 so they remain within the shaving razor container during the recycling shipping and processing process. The other shaving razors 62b and 62c, may be inserted into the shaving razor container 10 in a similar fashion. For example, the shaving razors 62a, 62b and 62c may be in the second position when they are new or are still being used. The consumer may place the shaving razors 62a, 62b and 62c in the first position when they no longer want to continue using the shaving razors 62a , 62b and 62c. In certain embodiments, once all of the shaving razors 62a, 62b and 62c are in the first position, the consumer may place the shaving razor container 10 (with the secured shaving razors 62a, 62b and 62c) in a recycling bin with other typical aluminum recyclable products, such as aluminum beverage cans. Accordingly, the shaving razor container 10 provides a simple and easy way to store the shaving razors 62a, 62b and 62c during use, but also facilitates the consumer recycling the shaving razors 62a, 62b and 62c when they no longer wish to shave with them. If the shaving razors 62a, 62b and 62c were to enter the recycling stream without being secured to the shaving razor container 10, they would end up being sorted out because they are too small and would end up in a land fill. Furthermore, the size and shape of the shaving razor container 10 is similar to items consumers are accustom to recycling.

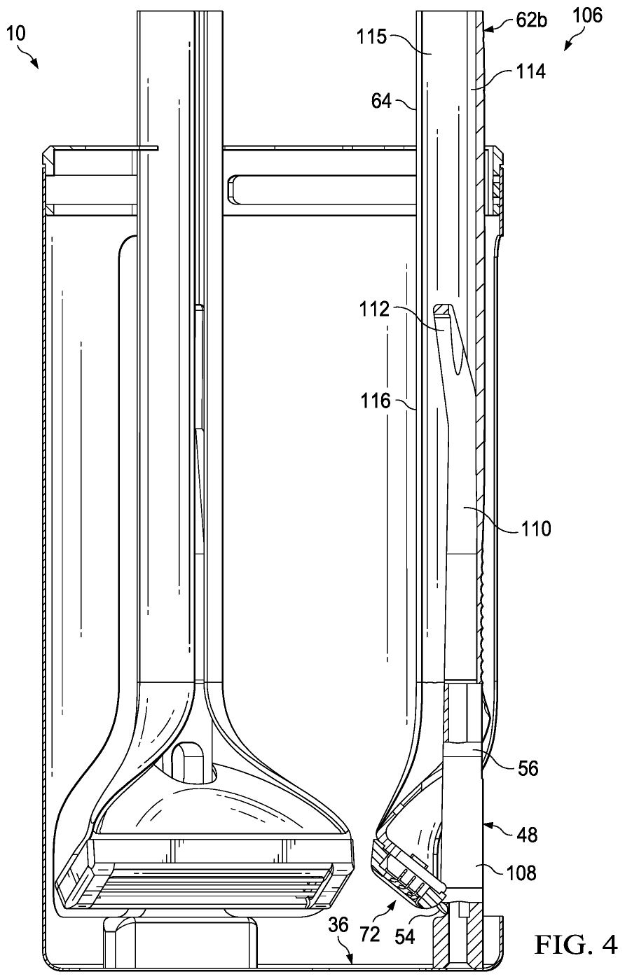

Referring to FIG. 4, a cross section view of the shaving razor container kit 106, taken generally along the line 4-4 of FIG. 3A. The projection 48 may include the lower portion 108 and an upper portion 110 that extends from the second resting surface 56. The upper portion 110 may extend into the opening 115 of the handle 64 (e.g., best shown as the handle 62b). The upper portion 84 may have a distal portion 112 that is spaced apart from a first and second inner side walls 114 and 116 of the handle 64 to facilitate the placement of the handle 64 over the projection 48 (e.g., distal end portion 112 and upper portion 110). The distal end portion 112 may extend inwardly to provide space between the shaving razor container 10. The projection 48 (e.g., the upper portion 110) may contact one of the inner side walls 114 between the distal end portion 112 and the lower portion 108. The projection 48 (e.g., the upper portion 110) may be spaced apart from the second inner side wall 116 and biased against the first inner side wall 114 to secure the handle 64 to the shaving razor container 10. The shaving razor cartridge 72 may be secured within the first resting surface (e.g., notch) 54 such that the shaving razor cartridge 72 is spaced apart from the bottom surface 36.

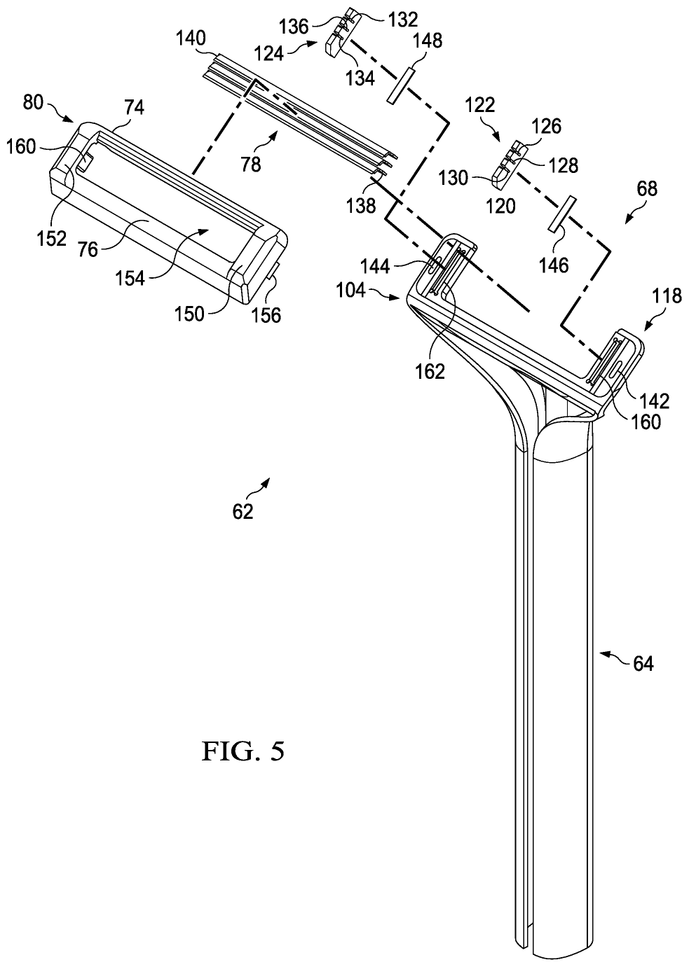

Referring to FIG. 5, an assembly view of the shaving razor 62 is illustrated. The platform 104 at the proximal end portion 68 of the shaving razor handle 64 may be bifurcated into two spaced apart arms 118 and 120 that may be attached to a pair of blade supports 122 and 124. Each of the blade members 78 may be mounted to the pair of blade supports 122 and 124. For example, the blade support 122 may have a plurality of slots 126, 128 and 130 dimensioned to received one of the respective blade members 78 Similarly, the blade support 124 may have a plurality of slots 132, 134 and 136 dimensioned to receive one of the corresponding blade members 78. In certain embodiments, a respective lateral end 138 and 140 of one of the blade members 78 may be positioned within one of the respective slots 126 and 132. Other blade members 78 may be mounted in a similar fashion. In certain embodiments, the blade members 78 may be fixed within the slots 126, 128, 130, 132, 134 and 136, for example, with adhesive. The blade supports 122 and 124 may be mounted and secured to the platform 104. For example, a portion of the blade supports 122 and 124 may be inserted into a respective aperture 142 and 144 in the platform 104 (e.g., by press fitting). In certain embodiments, a spring member 146 and 148, such as a silicone tube, may be positioned between the platform 104 and the respective blade supports 122 and 124. The spring members 146 and 148 may help locate the one or more blades 78 against the frame 80.

The frame 80 may be made from a unitary piece of ferrous metal or a unitary piece of non-ferrous metal to facilitate recycling. The material of the frame 80 may also be the same as the shaving razor handle 64 to further facilitate recycling. The top guard surface 76, the top cap surface 74 and a pair of top side surfaces 150 and 152 may define an opening 154. The frame 80 may be mounted over the pair of lateral ends 138 and 140 of the at least one blade member 78 and the pair of blade supports 122 and 124 so the at least one blade 78 is positioned within the opening 154. The frame 80 may be secured to the platform 104. For example, the frame 80 may have a pair of tabs 156 and 158 that are mounted within a pair of respective openings 160 and 162 of the arms 118 and 120 of the platform 104. The tabs 156 and 158 may be secured to the platform 104 (e.g., openings 160 and 162) by press fitting, adhesive or other known assembly methods. The pair of arms 118 and 120 may allow for improved unobstructed rinsing of the blade members 78, as the blade members 78 may be directly exposed to water between the arms 118 and 120.

FIG. 5 is a flowchart illustrating a method for recycling shaving razors in accordance with the present disclosure. With reference to FIG. 5, an exemplary method 164 for recycling shaving razors includes providing a plurality of shaving razors comprising at least 80% of a first metal by weight at Step 166. A shaving razor container comprising at least 80% of the first metal by weight is provided at step 168. At step 166, the plurality of shaving razors are positioned within the shaving razor container. The plurality of shaving razors may then be at least partially secured within the shaving razor container at step 172. It is understood the method 164 may include additional steps. For example, the shaving razor cartridge on each of the shaving razors may be positioned toward a bottom surface of the shaving razor container at step 166. In certain embodiments, the step 166 may also include providing recycling information on the shaving razor container. The first metal may comprise aluminum or steel. For example, a plurality of shaving razors may be provided comprising at least 80% of the first metal by weight and more preferably at least 90% by weight. The step 168 of providing a shaving razor container may include providing the shaving razor container comprising at least 90% of the first metal by weight. The method 164 may also include forming an upper opening in a top surface of the shaving razor container and forming a lower opening in a bottom surface of the shaving razor container that is in communication with the upper opening. The step 170 may include positioning an end of a handle of each of the plurality of shaving razors above a top surface of the container. The step 172 may include engaging a projection on the shaving razor container with an opening defined by one of the shaving razors.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.” Furthermore, dimensions should not be held to an impossibly high standard of metaphysical identity that does not allow for discrepancies due to typical manufacturing tolerances. Therefore, the term “about” should be interpreted as being within typical manufacturing and measuring tolerances.

Every document cited herein, including any cross referenced or related patent or application is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests, or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A shaving razor kit comprising:
a plurality of shaving razors each having a handle with a proximal end and a distal end, a plurality of shaving razor cartridges, each mounted to the corresponding proximal end of the handle;
a shaving razor container having a top surface defining and upper opening and a bottom surface that defines a lower opening in communication with the upper opening, wherein the shaving razors have a first position with the shaving razor cartridges positioned within the shaving razor container toward the bottom surface and the shaving razors have a second position with the shaving razor cartridges positioned externally of the shaving razor container.

2. The shaving razor kit of claim 1 wherein the plurality of shaving razors and the container are at least 80% aluminum by weight.

3. The shaving razor kit of claim 2 wherein a force to remove one of the shaving razors in the first position is greater than a force to remove one of the shaving razors in the second position.

4. The shaving razor kit of claim 1 wherein the distal end of the handles are positioned externally of the shaving razor container in the first position.

5. The shaving razor kit of claim 1 wherein the shaving razor container has a projection with a lower portion, a distal end portion and an upper portion between the distal end portion and the lower portion.

6. The shaving razor kit of claim 5 wherein the handles each defines an opening extending from the distal end of the respective handle to the proximal end of the respective handle.

7. The shaving razor kit of claim 6 the distal end portion and the upper portion of the projection is positioned within the opening of one of the handles.

8. The shaving razor kit of claim 7 wherein the upper portion contacts a first inner side wall of one of the handles and the distal end portion is spaced apart from the first inner side wall.

9. The shaving razor kit of claim 1 wherein the handles are positioned within the container offset by 110 to 130 degrees from each other.

10. A method of recycling comprising:
providing a plurality of shaving razors comprising at least 80% of a first metal by weight;
providing a shaving razor container comprising at least 80% of the first metal by weight;
positioning the plurality of shaving razors within the shaving razor container; and
securing the plurality of shaving razors at least partially within the shaving razor container.

11. The method of claim 10 wherein said positioning comprises positioning a shaving razor cartridge on each of the shaving razors toward a bottom surface of the shaving razor container.

12. The method of claim 11 further comprising providing recycling information on the shaving razor container.

13. The method of claim 11 further comprising releasably positioning the plurality of shaving razors in a second position with the shaving razor cartridges positioned externally of the shaving razor container.

14. The method of claim 10 wherein the first metal comprises aluminum.

15. The method of claim 10 wherein the first metal comprises steel.

16. The method of claim 10 wherein said providing the plurality of shaving razors comprises providing a plurality of shaving razors comprising at least 80% of the first metal by weight.

17. The method of claim 10 wherein said providing shaving razor container comprises providing the shaving razor container comprising at least 90% of the first metal by weight

18. The method of claim 10 further comprising forming an upper opening in a top surface of the shaving razor container and forming a lower opening in a bottom surface of the shaving razor container that is in communication with the upper opening.

19. The method of claim 10 wherein said positioning comprises positioning an end of a handle of each of the plurality of shaving razors above a top surface of the container.

20. The method of claim 10 wherein said securing comprises engaging a projection on the shaving razor container with an opening defined by one of the shaving razors.
